(19) United States
(12) Patent Application Publication
(10) Pub. No.: US 2026/0056366 A1
(43) Pub. Date: Feb. 26, 2026

(54) COMPACT OPTICAL DEVICE FOR WAVELENGTH DIVISION MULTIPLEXING (WDM) APPLICATIONS

(71) Applicant: MELLANOX TECHNOLOGIES, LTD., Yokneam (IL)

(72) Inventors: Alon GABBAY, Yokenam Ilit (IL); Liron GANTZ, Haifa (IL)

(73) Assignee: MELLANOX TECHNOLOGIES, LTD., Yokneam (IL)

(21) Appl. No.: 18/815,271

(22) Filed: Aug. 26, 2024

(51) Int. Cl. G02B 6/293

(52) U.S. Cl. CPC G02B 6/29323; G02B 6/2938

(57) ABSTRACT

An example optical device is disclosed, comprising a first optical waveguide and a second optical waveguide situated in proximity to the first optical waveguide. The first optical waveguide includes a first grating structure, while the second optical waveguide incorporates a second grating structure. The grating structures facilitate selective, directional coupling of specific wavelengths from the first waveguide to the second waveguide. The distance between the first and second optical waveguides varies along the interaction length so as to optimize the coupling efficiency and the extinction ratio (ER) of the device.

### TECHNOLOGICAL FIELD

Example embodiments of the present disclosure relate to a compact optical device for wavelength division multiplexing (WDM) applications.

### BACKGROUND

In optical communication systems, Contra-Directional Grating-assisted Couplers (CDGC) can be used for wavelength division multiplexing (WDM) demultiplexing, utilizing contra-directional coupling between waveguides via a grating structure for selective wavelength transfer. Current solutions to improve performance when using CDGC as WDM demultiplexers include operatively coupling multiple CDGCs in series. However, such solutions come with inherent trade-offs, notably in terms of the required physical footprint and the impact on insertion loss.

Applicant has identified a number of deficiencies and problems associated with the use of CDGC in WDM demultiplexing. Many of these identified problems have been solved by developing solutions that are included in embodiments of the present disclosure, many examples of which are described in detail herein.

### GENERAL DESCRIPTION

Systems and methods are therefore provided for a compact optical device for wavelength division multiplexing (WDM) applications, enabling the combination and separation of different wavelengths within a single optical waveguide, and is applicable to both communication and non-communication systems.

In one aspect, an optical device is presented. The optical device comprising: a first optical waveguide comprising a first grating structure; and a second optical waveguide comprising a second grating structure, wherein the second optical waveguide is disposed proximate the first optical waveguide to enable optical coupling between the first optical waveguide and the second optical waveguide along an interaction length, wherein a distance between the first optical waveguide and the second optical waveguide varies along the interaction length.

In some embodiments, the first grating structure and the second grating structure are configured to couple, from the first optical waveguide to the second optical waveguide, a subset of a plurality of wavelengths of an optical signal propagating through the first optical waveguide.

In some embodiments, the optical signal propagates via the first optical waveguide in a first direction, and wherein coupling further comprises coupling the subset of the plurality of wavelengths of the optical signal from the first optical waveguide to the second optical waveguide in a direction opposite to the first direction.

In some embodiments, the optical device is a contra-directional grating-assisted coupler (CDGC).

In some embodiments, the distance between the first optical waveguide and the second optical waveguide varies along the interaction length according to a mathematical function.

In some embodiments, the mathematical function comprises at least one of a sine function, a cosine function, or a Gaussian function.

In some embodiments, a coupling strength between the first optical waveguide and the second optical waveguide along the interaction length changes based on the distance between the first optical waveguide and the second optical waveguide.

In some embodiments, the coupling strength between the first optical waveguide and the second optical waveguide is at a maximum where the distance between the first optical waveguide and the second optical waveguide is at a minimum, and wherein the coupling strength between the first optical waveguide and the second optical waveguide is at a minimum where the distance between the first optical waveguide and the second optical waveguide is at a maximum.

In some embodiments, the distance between the first optical waveguide and the second optical waveguide is at a minimum at a midpoint of the interaction length.

In some embodiments, the first grating structure and the second grating structure are corrugations.

In another aspect, a method for demultiplexing an optical signal using an optical device is presented. The method comprising: receiving an optical signal for propagation via a first optical waveguide, wherein the optical signal comprises a plurality of wavelengths; coupling a subset of the plurality of wavelengths of the optical signal from the first optical waveguide to a second optical waveguide for propagation; and transmitting, via the second optical waveguide, the subset of the plurality of wavelengths of the optical signal to an external device, wherein a distance between the first optical waveguide and the second optical waveguide varies along an interaction length associated with the first optical waveguide and the second optical waveguide.

In yet another aspect, a system is presented. The system comprising: an optical signal generator configured to generate an optical signal, wherein the optical signal comprises a plurality of wavelengths; and an optical device operatively coupled to the optical signal generator and configured to: receive the optical signal via a first optical waveguide; couple a subset of the plurality of wavelengths of the optical signal from the first optical waveguide to a second optical waveguide for propagation; and transmit, via the second optical waveguide, the subset of the plurality of wavelengths of the optical signal to an external device, wherein a distance between the first optical waveguide and the second optical waveguide varies along an interaction length associated with the first optical waveguide and the second optical waveguide.

### BRIEF DESCRIPTION OF THE DRAWINGS

Having described certain example embodiments of the present disclosure in general terms above, reference will now be made to the accompanying drawings. The components illustrated in the figures may or may not be present in certain embodiments described herein. Some embodiments may include fewer (or more) components than those shown in the figures.

FIGS. 1A-1C illustrate an example optical device, in accordance with embodiments of the present disclosure;

FIGS. 2A-2C illustrates an example spectral response demonstrating a performance of the optical device for demultiplexing an optical signal, in accordance with an embodiment of the disclosure;

FIG. 3 illustrates an example method for demultiplexing an optical signal, in accordance with an embodiment of the disclosure;

FIG. 4 illustrates an example communication system, in accordance with an embodiment of the disclosure;

FIG. 5 illustrates an example system for multiplexing or demultiplexing an optical signal using an optical device, in accordance with an embodiment of the disclosure; and

FIG. 6 illustrates an example computer system including a transceiver including a chip-to-chip interconnect, in accordance with an embodiment of the disclosure.

### DETAILED DESCRIPTION

### Overview

A Contra-Directional Grating-assisted Coupler (CDGC) operates based on the principle of contra-directional coupling between two waveguides, facilitated by a grating structure that induces selective wavelength transfer from one waveguide to another in the opposite direction. In a CDGC, two waveguides are placed in close proximity, with at least one waveguide incorporating a periodic grating. The grating introduces a periodic variation in the refractive index along the waveguide, which can couple light of specific wavelengths from the waveguide in which the light is initially propagating to the adjacent waveguide, with the light in the second optical waveguide propagating in the opposite direction. The operational principles of CDGC may be leveraged to employ the CDGC as a wavelength division multiplexing (WDM) de-multiplexer.

In WDM, multiple optical signals (e.g., data signals or data streams) having different wavelengths can be combined into a single optical signal and transmitted over a single optical fiber (e.g., simultaneous transmission of multiple wavelengths of light). More specifically, WDM techniques can generally involve combining and separating multiple optical signals having different wavelengths onto a single optical fiber. By doing so, WDM technology can allow for more data to be transmitted over an optical fiber and/or increase the capacity of the optical fiber.

Examples of WDM technology includes coarse wavelength division multiplexing (CWDM) and dense wavelength division multiplexing (DWDM). In CWDM, multiple optical signals (e.g., data signals or data streams) at different wavelengths are combined into a single optical signal and transmitted over a single optical fiber. The names CWDM and DWDM refer to the coarseness and denseness, respectively, of wavelength separation between wavelengths. More specifically, CWDM uses a coarser or wider wavelength separation than DWDM, which uses a denser or narrower wavelength separation. For example, wavelengths for CWDM can be separated by, e.g., about 20 nanometers (nm), while wavelengths for DWDM can be separated by, e.g., about 0.8 nm. The wider wavelength separation used in CWDM means that CWDM can support fewer channels and have lower power budgets than DWDM, and so CWDM can be used for shorter distances than DWDM, such as, e.g., up to about 80 kilometers (km). At the same time, CWDM uses less complex equipment and can use lower-cost optical components as compared to DWDM, which can make it a more cost-effective solution for applications that may not require denser wavelength separation.

In optical communication systems, multiplexers and de-multiplexers play crucial roles in combining and separating multiple wavelengths of light, respectively. Mach-Zehnder Interferometers (MZIs) and ring-assisted MZIs are commonly used for these purposes. However, their operation is highly sensitive to environmental changes and fabrication tolerances. As a result, MZIs and ring-assisted MZIs typically require additional feedback loops to maintain a correct working point. These feedback loops involve monitoring the output and making continuous adjustments to counteract any drifts or deviations, which increases system complexity and resource requirements. In contrast, grating couplers, and specifically, CGDCs, offer a more robust alternative for use as multiplexers and de-multiplexers. The CGDCs benefit from a design-controlled spectral passband, which inherently stabilizes their operational characteristics. This design feature reduces the dependency on external feedback mechanisms to maintain a correct working point. Specifically, CGDCs can be configured to have precise wavelength-selective properties through the design of their grating structures. As a result, they exhibit less sensitivity to environmental fluctuations and fabrication variations. Furthermore, to address temperature changes, as CGDC does not require feedback loops to maintain working point, a simple look-up-table (LUT) or temperature sensor may be used to tune the optical device as temperatures fluctuate.

The inherent stability of the spectral passband in CGDCs simplifies their operation and maintenance. Because the spectral characteristics are determined by the physical design of the grating, rather than dynamic adjustments, CGDCs can consistently perform their multiplexing and de-multiplexing functions with fewer resources dedicated to maintaining operational stability, thus having a smaller silicon footprint. This configuration not only reduces the overall system complexity but also enhances the reliability and efficiency of optical communication networks.

The performance of a demultiplexer in optical communication systems may be measured based on the extinction ratio (ER). A high ER indicates that the device effectively discriminates between desired and undesired wavelengths, allowing only the target wavelengths to pass through while significantly attenuating others. Current solutions to improve ER when using CDGC as WDM demultiplexers include operatively coupling multiple CDGCs in series. However, such solutions come with inherent trade-offs, notably in terms of the required physical footprint and the impact on insertion loss.

Embodiments of the disclosure contemplate a novel design for a CDGC by varying the gap between the two corrugated waveguides in the CDGC gradually. The distance between the first and second optical waveguides varies along the interaction length so as to optimize the coupling efficiency and the extinction ratio (ER) of the device. The gap between the two waveguides may influence the ER of the CDGC. In example embodiments, the variation in the gap may be governed by a specific mathematical function, such as a sine function, a cosine function, a Gaussian function, and/or the like. By configuring the gap to vary adiabatically along the interaction length of the waveguides, embodiments of the disclosure optimize the overlap of the near-field effects extending from each waveguide, thereby increasing the ER of the CGDC. In this configuration, as light travels along the waveguides, the coupling strength begins to increase due to a progressively decreasing distance between the waveguides along their interaction lengths. This increase in coupling strength gradually continues until it reaches its maximum value at the midpoint of the interaction length, where the gap between the waveguides is at a minimum. Beyond this midpoint, the coupling strength begins to decrease due to a progressively increasing distance between the waveguides, until it eventually becomes negligible towards the exit point of the interaction region.

The novel configuration provides in the spectral response of the CDGC, a reduction in the intensity of sidelobes outside the passband. This decrease in sidelobe strength contributes to achieving an increased ER between the wavelengths within the passband and those outside of the passband, resulting in improved wavelength discrimination and signal integrity. The ER between a wavelength at the center of the passband and a wavelength outside the passband is high enough so that a single device is sufficient to act as an efficient WDM demultiplexer. As such, the novel configuration contemplated herein can be integrated into future optical engine technologies, such as those used in co-packaged optics.

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, “operatively coupled” may mean that the components are electronically or optically coupled and/or are in electrical or optical communication with one another. Furthermore, “operatively coupled” may mean that the components may be formed integrally with each other or may be formed separately and coupled together. Furthermore, “operatively coupled” may mean that the components may be directly connected to each other or may be connected to each other with one or more components (e.g., connectors) located between the components that are operatively coupled together. Furthermore, “operatively coupled” may mean that the components are detachable from each other or that they are permanently coupled together.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, satisfied, etc.

It should be understood that the word “exemplary” is used herein to mean “serving as an example, instance, or illustration.” Any implementation described herein as “exemplary” is not necessarily to be construed as advantageous over other implementations.

Furthermore, as would be evident to one of ordinary skill in the art in light of the present disclosure, the terms “substantially” and “approximately” indicate that the referenced element or associated description is accurate to within applicable engineering tolerances.

### Example Optical Device

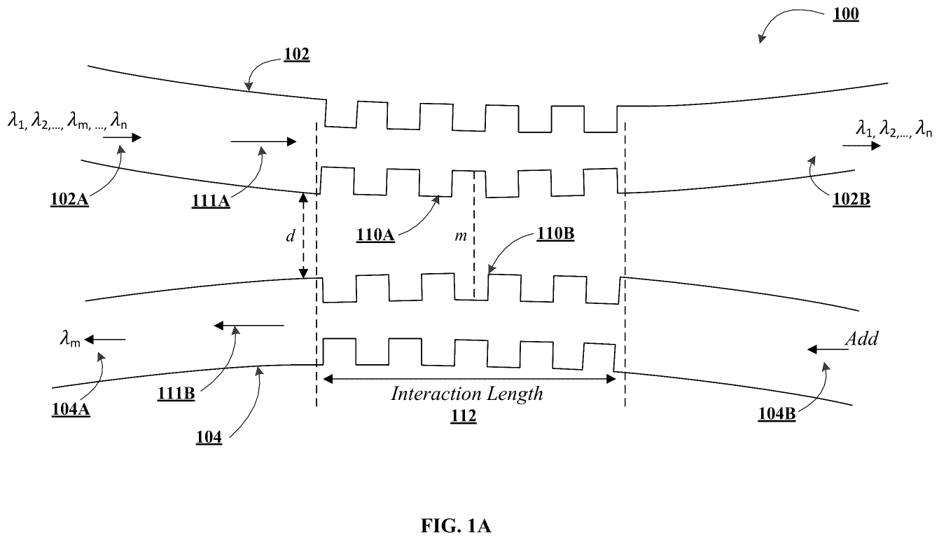

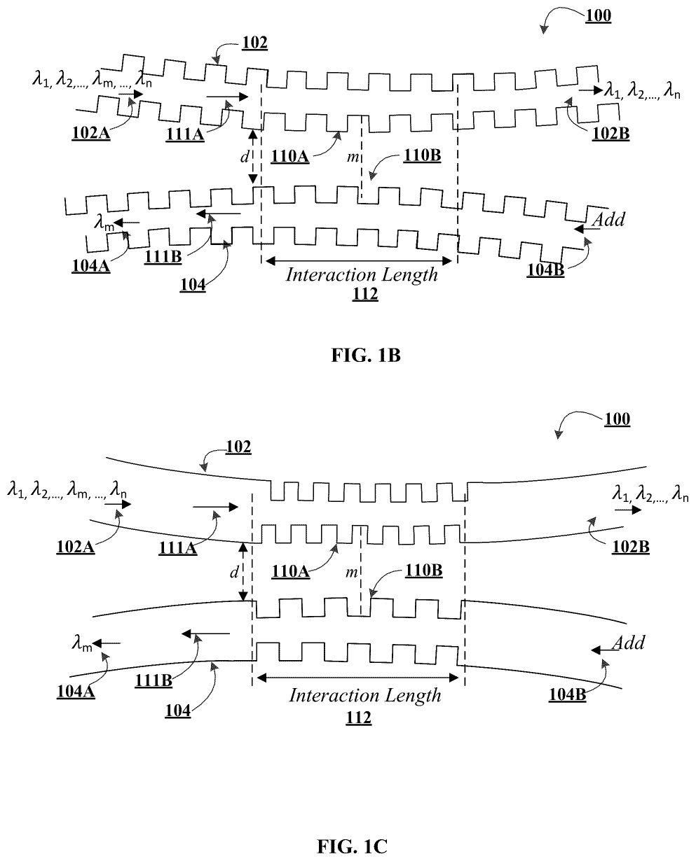

FIG. 1A illustrates an example optical device 100, in accordance with an embodiment of the present disclosure. As shown in FIG. 1A, the optical device 100 (e.g., a CDGC) may include a first optical waveguide 102 and a second optical waveguide 104.

The first optical waveguide 102 may be a physical structure configured to guide light waves along a predetermined path. The first optical waveguide 102 may be configured for controlled transmission of optical signals over distances. The first optical waveguide 102 may have a first end 102A and a second end 102B. The first optical waveguide 102 may be configured to receive an optical signal 106 from an external source (not shown) via the first end 102A, and subsequently facilitate propagation of the optical signal 106 therethrough in a first direction 111A. The optical signal 106 may be a multiplexed beam comprising a plurality of discrete wavelengths (e.g., λ_{1,} λ_{2, . . . ,} λₘ₁, . . . , λ_{mk, . . . ,} λₙ). When particular wavelengths (e.g., λₘ₁, . . . , λₘₖ) of the optical signal 106 are extracted and inserted into the coupled second optical waveguide 104, as described herein, the non-extracted wavelengths (e.g., λ_{1,} λ_{2, . . . ,} λₙ) of the optical signal 106 may continue to propagate through the first optical waveguide 102 and exit from the second end 102B of the first optical waveguide. This residual optical signal, containing the non-extracted wavelengths (e.g., λ_{1,} λ_{2, . . . ,} λₙ), can be directed to subsequent stages of the optical system or to an external optical device for further processing, utilization, or analysis. For instance, the continuing signal may be used in additional demultiplexing stages, amplified for extended transmission, or monitored for network diagnostics.

The first optical waveguide 102 may be a narrow, elongated structure made of a transparent dielectric material with a high refractive index core surrounded by a lower refractive index cladding. The first optical waveguide 102 may be symmetrical or asymmetrical in structure. As such, the first optical waveguide 102 may be cylindrical, made of glass or plastic that is flexible and can be bundled as fibers. In other embodiments, the first optical waveguide 102 may comprise planar waveguides fabricated on a substrate and used in integrated optical circuits (IOCs), strip waveguides, rib waveguides, and/or the like. In specific embodiments, the first optical waveguide 102 may have a corrugated structure, implemented as periodic variations in the width or sidewall angulation of the first optical waveguide 102 that contribute to the waveguide's ability to maintain a single-mode operation across a broad spectrum. The corrugation in first optical waveguide 102 may ensure that as the optical signal 106 enters, the optical signal 106 is effectively guided with minimal loss while preserving the modal characteristics used for the coupling process that occurs subsequently.

The second optical waveguide 104, similar to the first optical waveguide 102, may be configured to facilitate the transmission of particular wavelengths (e.g., λₘ₁, . . . , λₘₖ) of the optical signal 106 coupled from the first optical waveguide 102 therethrough. The second optical waveguide 104 may have a first end 104A and a second end 104B. The coupling and dropping of selected wavelengths (e.g., λₘ₁, . . . , λₘₖ) from the first optical waveguide 102 to the second optical waveguide 104 occur within the interaction length 112. This process effectively “drops” the specified wavelength(s) from the multiplexed optical signal traveling in the first optical waveguide 102, diverting them into the second optical waveguide 104 for further processing or output. In specific embodiments, the second optical waveguide 104 may also be capable of introducing additional optical signals, via the second end 104B, into the flow of the extracted wavelengths, effectively “adding” them to be transmitted along with the coupled wavelengths. The integration of the “drop” and “add” functionalities within the architecture of the second optical waveguide 104 enables more efficient manipulation of optical signals, thereby supporting complex operations in optical communication networks. This includes, but is not limited to, routing specific wavelengths to different destinations, inserting new data channels into an existing optical stream, or extracting channels for signal analysis or processing.

The second optical waveguide 104 may be a similarly narrow, elongated structure composed of a transparent dielectric material, characterized by a high refractive index core encased within a cladding of a lower refractive index. Similar to the first optical waveguide 102, the second optical waveguide 104 may also be symmetrical or asymmetrical in structure. Such a configuration may render the second optical waveguide 104 cylindrical in shape, constructed from materials such as glass or plastic, which afford the flexibility required for bundling into fibers. Additionally, the second optical waveguide 104 may be fabricated as planar waveguides on substrates for use in IOCs, or designed as strip waveguides, rib waveguides, among other forms. In certain embodiments, the second optical waveguide 104 may have a corrugated structure, implemented as periodic variations in the width or sidewall angulation of the second waveguide 104 that contribute to the waveguide's ability to maintain a single-mode operation across a broad spectrum. It is to be understood that the descriptions provided herein for the first optical waveguide 102 and second optical waveguide 104 are illustrative rather than exhaustive. Notwithstanding the foregoing descriptions that discuss similarities in structure between the first optical waveguide 102 and the second optical waveguide 104 within the disclosed disclosure, such descriptions shall not be construed as a limitation or negation of the potential for other structural configurations, insofar as these configurations allow the waveguides to perform their prescribed functional roles, as shown in FIGS. 1B and 1C. As shown in FIG. 1A, the first optical waveguide 102 may have a first grating structure 110A embedded thereon. Similarly, the second optical waveguide 104 may have a second grating structure 110B embedded thereon. The first grating structure 110A and the second grating structure 110B may be configured to facilitate the selective coupling of specific wavelengths from the first optical waveguide 102 to the second optical waveguide 104. These grating structures (e.g., the first grating structure 110A and the second grating structure 110B) may function by creating periodic variations in the refractive index along their respective waveguides, which are finely tuned to interact with specific wavelengths of the optical signal.

The grating structures 110A and 110B, which refer to the corrugations in the first optical waveguide 102 and the second optical waveguide 104 respectively, may include a series of grating elements, each configured to facilitate the selective transfer of optical signals from one waveguide to the other. These grating elements may be arranged in a manner that supports directional coupling. In specific embodiments, the grating elements may be arranged to support contra-directional coupling, a process where optical signals propagating in one direction (e.g., 111A) in one waveguide are transferred in to another waveguide in which the optical signals propagate in an opposite direction (e.g., 111B), as shown in FIG. 1A. This arrangement is used to achieve high selectivity and efficiency in the coupling process, allowing for the targeted extraction or insertion of specific wavelengths from the multiplexed optical signal propagating through the first optical waveguide 102. The grating elements in the grating structures 110A and 110B may be configured to interact with a specific subset of wavelengths (e.g., λₘ₁, . . . , λₘₖ) from the broad spectrum of wavelengths (e.g., λ_{1,} λ_{2, . . . ,} λₘ₁, . . . , λ_{mk, . . . ,} λₙ) of the optical signal in the first optical waveguide 102. This selective interaction may be achieved through the design of the grating pitch and the spatial period of the grating elements, which determines the phase matching conditions for coupling specific wavelengths from the first optical waveguide 102 to the second optical waveguide 104. By configuring the grating elements to have particular geometric and optical properties, such as their size, shape, and refractive index modulation, the grating structures 110A and 110B may efficiently couple a designated subset of wavelengths out of the multiplexed signal in the first optical waveguide 102 and into the second optical waveguide 104.

In an example operation, the optical signal may propagate through the first optical waveguide 102 in a first direction 111. As the optical signal encounters the first grating structure 110A, the grating structure 110A may selectively couple certain wavelengths of the optical signal to the second grating structure 110B in the adjacent second optical waveguide 104. This coupling may be contra-directional, meaning the extracted wavelengths are transferred to the second optical waveguide 104 in a direction opposite to the propagation direction of the original optical signal in the first optical waveguide 102. The first and second grating structures 110A and 110B may be configured to optimize the efficiency of the contra-directional coupling. The periodicity of the grating structures 110A, 110B may be configured to match the phase matching conditions necessary for coupling the targeted wavelengths while minimizing the coupling of non-targeted wavelengths. Such a selective coupling mechanism may improve the wavelength division multiplexing (WDM) capabilities of the system by ensuring that only the desired wavelengths are diverted into the second optical waveguide 104.

Contra-directional propagation may occur when the following equation is met:

$$Δβ = β1 + \vert β2 \vert - m \frac{2 π}{Λ} ,$$

where β may depend on the effective index of each optical waveguide (without corrugations). The effective index may be a function of the width and height of the waveguide, as well as the refractive index of the waveguide and the surrounding materials. Λ may represent the period (in units of length) of the corrugations. The above equation may be calculated for each wavelength that is to be used. Other parameters, such as the length of the device, the depth of the corrugations, and the depth of the etch, are typically determined experimentally to optimize the response of the CDGC.

As shown in FIG. 1A, the first optical waveguide 102 and the second optical waveguide 104 may be disposed proximate to each other, lengthwise, to enable optical coupling therebetween along an interaction length 112. This proximity facilitates the efficient transfer of selected wavelengths (e.g., λₘ₁, . . . , λₘₖ) from the first optical waveguide 102 to the second optical waveguide 104, as governed by the contra-directional grating structure 110 (described in further detail herein). As such, the first optical waveguide 102 and the second optical waveguide 104 may be positioned such that a specified distance, denoted as d in FIG. 1A, is maintained between them. In specific embodiments, the first optical waveguide 102 and the second optical waveguide 104 may be disposed in such a way that the distance, d, may vary along the interaction length 112. The variation in the distance, d, may be based on mathematical function such as a sine function, cosine function, Gaussian function, and/or the like. In example embodiments, the distance, d, between the first optical waveguide and the second optical waveguide is at a minimum at a midpoint m of the interaction length 112.

The distance, d, may influence the coupling strength between the first optical device 102 and the second optical device 104. The coupling strength may refer to the efficiency and effectiveness of optical signal transfer from the first optical waveguide 102 to the second optical waveguide 104. A smaller distance between the two optical waveguides typically leads to a stronger coupling, as the evanescent fields of the guided modes in the optical waveguides overlap more significantly. As such, there is a need to balance the smaller distance with the necessity to mitigate interference and maintain signal quality.

In specific embodiments, the coupling strength between the first optical waveguide 102 and the second optical waveguide 104 along the interaction length 112 may change based on the distance, d. For instance, the coupling strength between the first optical waveguide 102 and the second optical waveguide 104 may be at a maximum where the distance, d, between the first optical waveguide 102 and the second optical waveguide 104 is at a minimum. Similarly, the coupling strength between the first optical waveguide 102 and the second optical waveguide 104 may be at a minimum where the distance, d, between the first optical waveguide 102 and the second optical waveguide 104 is at a maximum.

It is to be understood that the structure of the optical device 100 and its components, connections and relationships, and associated functions, are meant to be exemplary only, and are not meant to limit implementations of the disclosures described and/or claimed in this document. Furthermore, it is to be understood that the implementation of the device is not limited to specific materials; the optical device can utilize any two materials with differing refractive indices within the desired wavelength range, which typically includes wavelengths around 1310 nm for silicon photonics in communication systems. A particular focus may be on silicon (Si)-based platforms, and may be fabricated in various Si fabs with different processes, where the key factors may include the resultant geometrical resolution and surface roughness.

### Example Spectral Response

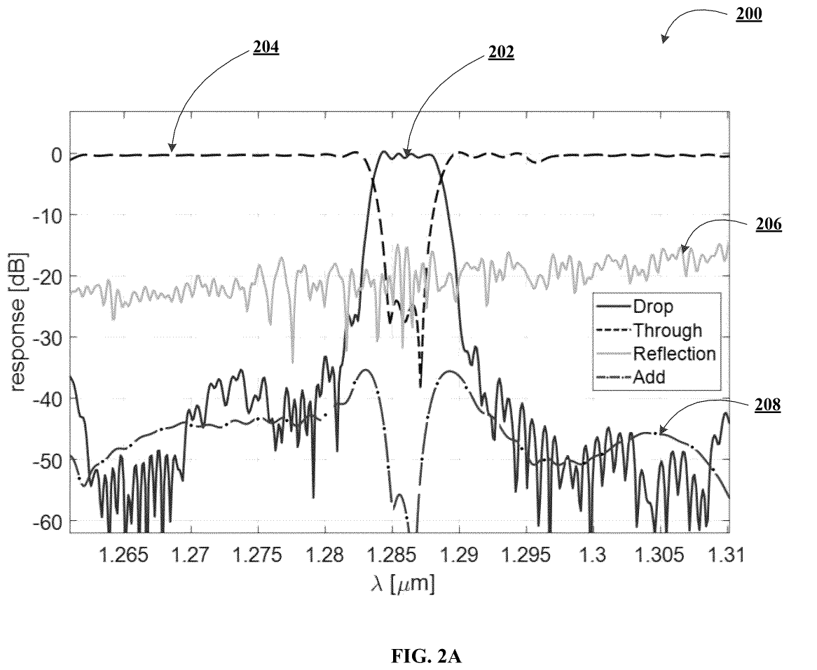

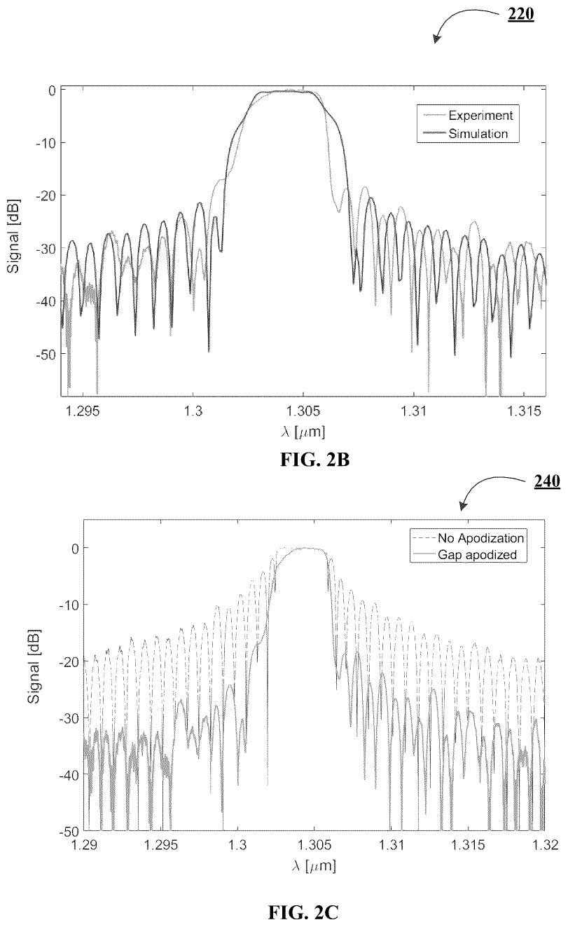

FIGS. 2A-2C depict example spectral responses illustrating a performance of the optical device 100 for demultiplexing an optical signal, in accordance with an embodiment of the disclosure. FIG. 2A illustrates an example simulated spectral response 200. As shown in FIGS. 2A, the spectral response 200, the “drop” response 202 illustrates the efficiency with which the desired wavelengths (e.g., λₘ₁, . . . , λₘₖ, which range from approximately 1.28 μm to 1.291 μm) are extracted from the multiplexed optical signal in the first optical waveguide and coupled into the second optical waveguide. The drop response 202 shows a sharp drop in the response on either side of the extracted wavelengths (e.g., λₘ₁, . . . , λₘₖ) indicating a high ER and high level of efficiency in the selective wavelength extraction.

As shown in FIG. 2A, the “through” response 204 illustrates the residual signal that continues to propagate through the first optical waveguide and exits at the second end of the first optical waveguide after the selective wavelengths have been dropped. The through response 204 shows a drop in the response coinciding with the extracted wavelengths, indicating effective isolation of the desired wavelengths from the multiplexed optical signal.

As shown in FIG. 2A, the “reflection” response 206 indicates a portion of the signal that is not successfully transmitted through the first optical waveguide but is instead reflected toward the source (e.g., the first end of the first optical waveguide). In an ideal scenario for an optical device designed to minimize signal loss, this reflection should be as low as possible across the entire wavelength range because reflection can lead to diminished signal power in the forward direction and potential interference with incoming signals, which could degrade system performance. Any peaks in the reflection response 206 can indicate wavelengths where a higher amount of light is reflected toward the source, which could be due to mismatches in the waveguide structure, imperfections in the grating, or other factors that cause backscattering. Here, the reflection response 206 overall has minimal peaks, indicating efficient optical signal transmission through the first optical waveguide.

As shown in FIG. 2A, the “add” response 208 shows how well additional optical signals are coupled into the second end of the second optical waveguide. In systems where adding channels into an existing stream is required, a pronounced peak in the add response would demonstrate effective coupling of new wavelengths into the system. Here, the add response 208 does not include any pronounced peak, indicating that no additional optical signal was added. However, if there had been an additional optical signal, a pronounced peak would be expected in the add response.

FIG. 2B illustrates the comparison 220 between the drop port's simulation result 202 (as shown in FIG. 2A) and the corresponding experimental measurement. FIG. 2C illustrates the measurements 240 from real devices based on the design simulated in FIG. 2A, showcasing the improvement in the spectral response between the “regular” CDGC design and a “gap-apodized” CDGC design, using the “drop” port spectra 202 (as shown in FIG. 2A) as an example.

It is to be understood that the spectral response of the optical device described herein is exemplary and illustrative of a specific embodiment of the disclosure. The actual response may vary according to the precise configuration, material properties, and operating conditions of the device. The example described above should not be construed to limit the disclosure to the particular spectral response or wavelengths shown, as other configurations yielding different responses are also within the scope of the disclosure and can be optimized based on the requirements of the application at hand.

### Example Method for Demultiplexing an Optical Signal

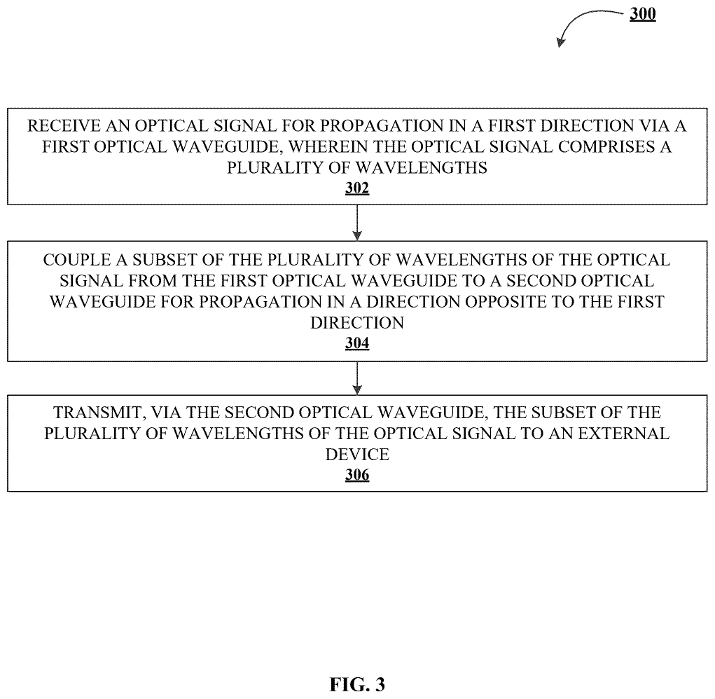

FIG. 3 illustrates an example method 300 for demultiplexing an optical signal, in accordance with an embodiment of the disclosure. As shown in block 302, an optical signal having a plurality of wavelengths may be received at a first optical waveguide (e.g., first optical waveguide 102, as illustrated in FIG. 1A) for propagation therethrough in a first direction. The optical signal may be received, for example, from a light source. The optical signal may be generated by a light source, which may include, but is not limited to, a laser, light-emitting diode (LED), or any suitable electromagnetic radiation source capable of producing the optical signal. The optical signal may have various wavelengths that are multiplexed, combining multiple optical signals at various wavelengths into a single optical fiber for transmission. As such, the multiplexed optical signal may be a composite that consists of several discrete wavelengths (e.g., λ_{1,} λ_{2, . . . ,} λₘ₁, . . . , λ_{mk, . . . ,} λₙ), each potentially carrying independent channels of data. The multiplexing of various wavelengths into a single optical signal may be achieved through several techniques, with wavelength division multiplexing (WDM) being among the most prevalent in optical communication. WDM allows for multiple optical carrier signals, each at different wavelengths, to be transmitted simultaneously over a single optical fiber. It is to be understood that the use of WDM is only exemplary, and other multiplexing techniques may be employed for the same purpose without departing from the scope and essence of the disclosure. Accordingly, the disclosure should not be construed as limited to any specific multiplexing methodology, as it encompasses the application of any such techniques that serve to enhance the efficiency and capacity of optical signal transmission.

As described herein, the optical signal may be received at a first end (e.g., first end 102A, as illustrated in FIG. 1A) of the first optical waveguide. The first optical waveguide may be configured to guide the optical signal in the first direction along a designated path within the structure of first optical waveguide.

As shown in block 304, a subset of the plurality of wavelengths of the optical signal may be coupled from the first optical waveguide (e.g., first optical waveguide 102) to a second optical waveguide (e.g., second optical waveguide 104) in a direction opposite to the first direction. As described herein, the first optical waveguide and the second optical waveguide may have grating structures embedded thereon. For example, the first optical waveguide may have a first grating structure 110A embedded thereon, and the second optical waveguide may have a second grating structure 110B embedded thereon. The grating structures in the first optical waveguide and the second optical waveguide may be configured to facilitate the selective coupling of specific wavelengths from the first optical waveguide to the second optical waveguide. These grating structures may function by creating periodic variations in the refractive index along their respective waveguides, which are finely tuned to interact with specific wavelengths of the optical signal. The grating structures may include a series of grating elements, each configured to facilitate the selective transfer of optical signals from one waveguide to the other. As described herein, these grating elements may be arranged in a manner that supports contra-directional coupling, a process where optical signals propagating in one direction (e.g., 111A) in one waveguide are transferred into another waveguide in which the optical signals propagate in an opposite direction (e.g., 111B).

The grating elements in the grating structures may be configured to interact with a specific subset of wavelengths (e.g., λₘ₁, . . . , λₘₖ) from the broad spectrum of wavelengths (e.g., λ₁, λ₂, . . . , λₘ₁, . . . , λₘₖ, . . . , λₙ) of the optical signal in the first optical waveguide. Such a selective interaction may be achieved through the design of the grating pitch and the spatial period of the grating elements, which determines the phase matching conditions for coupling specific wavelengths from the first optical waveguide to the second optical waveguide. By configuring the grating elements to have particular geometric and optical properties, such as their size, shape, and refractive index modulation, the grating structures may efficiently couple a designated subset of wavelengths out of the multiplexed signal in the first optical waveguide and into the second optical waveguide.

As described herein, the distance between the first optical waveguide and the second optical waveguide may vary along their interaction length, which may be defined by the grating structure. The interaction length may refer to the length over which the optical waveguides, enabled by the grating structure, may interact with each other to enable optical signal coupling. The distance between the first optical waveguide and the second optical waveguide may influence the strength and efficiency of optical coupling. In example embodiments, the distance between the optical waveguides may be varied according to a mathematical function, such as a sine function, a cosine function, a Gaussian function, and/or the like. As a result, a coupling strength between the first optical waveguide and the second optical waveguide along the interaction length may change based on the distance between the first optical waveguide and the second optical waveguide. Specifically, as the optical signal propagates through the first optical waveguide, the coupling strength between the first optical waveguide and the second optical waveguide may begin to increase due to a progressively decreasing distance between the waveguides along their interaction lengths. This increase in coupling strength may continue until it reaches its maximum value at the midpoint m of the interaction length, where the gap between the first optical waveguide and the second optical waveguide is at a minimum. Beyond this midpoint m, the coupling strength begins to decrease due to a progressively increasing distance between the waveguides, until the coupling strength eventually becomes negligible toward the exit point of the interaction region.

As shown in block 306, the subset of the plurality of wavelengths may be transmitted to an external device. This transmission involves the transfer of the previously extracted wavelengths from the second optical waveguide to an external processing or utilization device (not shown in FIG. 1A). The external device may be configured to further process, interpret, or otherwise utilize the information carried by these wavelengths. This may include, but is not limited to, converting optical signals into electrical signals through the use of photodetectors or similar conversion technologies, decoding the data encoded within the optical signals, or routing the signals to additional components or systems for further use.

### Example Communication System

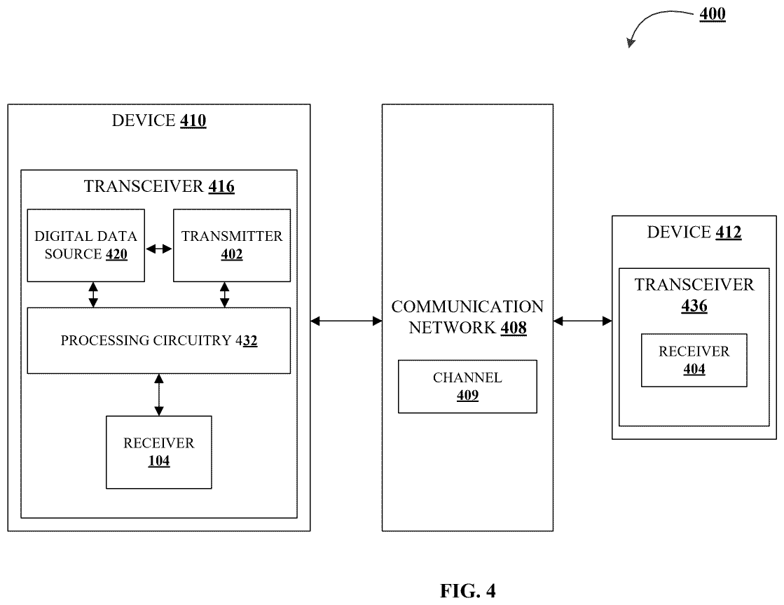

FIG. 4 illustrates an example communication system 400, in accordance with an embodiment of the disclosure. The system 400 includes a device 410, a communication network 408 including a communication channel 409, and a device 412. In at least one embodiment, devices 410 and 412 are two end-point devices in a computing system, such as a central processing unit (CPU) or graphics processing unit (GPU). In at least one embodiment, devices 410 and 412 are two servers. In at least one example embodiment, devices 410 and 412 correspond to one or more of a Personal Computer (PC), a laptop, a tablet, a smartphone, a server, a collection of servers, or the like. In some embodiments, the devices 410 and 412 may correspond to any appropriate type of device that communicates with other devices connected to a common type of communication network 408. According to embodiments, the receiver 404 of devices 410 or 412 may correspond to a GPU, a switch (e.g., a high-speed network switch), a network adapter, a CPU, a memory device, an input/output (I/O) device, other peripheral devices or components on a system-on-chip (SoC), or other devices and components at which a signal is received or measured, etc. As another specific but non-limiting example, the devices 410 and 412 may correspond to servers offering information resources, services, and/or applications to user devices, client devices, or other hosts in the system 400. In one example, devices 410 and 412 may correspond to network devices such as switches, network adapters, or data processing units (DPUs).

Examples of the communication network 408 that may be used to connect the devices 410 and 412 include an Internet Protocol (IP) network, an Ethernet network, an InfiniBand (IB) network, a Fibre Channel network, the Internet, a cellular communication network, a wireless communication network, a ground referenced signaling (GRS) link, combinations thereof (e.g., Fibre Channel over Ethernet), variants thereof, and/or the like. In one specific but non-limiting example, the communication network 408 is a network that enables data transmission between the devices 410 and 412 using data signals (e.g., digital, optical, wireless signals).

The device 410 includes a transceiver 416 for sending and receiving signals, for example, data signals. The data signals may be digital or optical signals modulated with data or other suitable signals for carrying data.

The transceiver 416 may include a digital data source 420, a transmitter 402, a receiver 404, and processing circuitry 432 that controls the transceiver 416. The digital data source 420 may include suitable hardware and/or software for outputting data in a digital format (e.g., in binary code and/or thermometer code). The digital data output by the digital data source 420 may be retrieved from memory (not illustrated) or generated according to input (e.g., user input).

The transmitter 402 includes suitable software and/or hardware for receiving digital data from the digital data source 420 and outputting data signals according to the digital data for transmission over the communication network 408 to a receiver 404 of device 412. Additional details of the structure of the transmitter 402 are discussed in more detail below with reference to the figures.

The receiver 404 of devices 410 and 412 may include suitable hardware and/or software for receiving signals, such as data signals from the communication network 408. For example, the receiver 404 may include components for receiving optical signals.

The processing circuitry 432 may comprise software, hardware, or a combination thereof. For example, the processing circuitry 432 may include a memory including executable instructions and a processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, the processing circuitry 432 may comprise hardware, such as an application-specific integrated circuit (ASIC). Other non-limiting examples of the processing circuitry 432 include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry 432 may be provided on a Printed Circuit Board (PCB) or collection of PCBs. It should be appreciated that any appropriate type of electrical component or collection of electrical components may be suitable for inclusion in the processing circuitry 432. The processing circuitry 432 may send and/or receive signals to and/or from other elements of the transceiver 416 to control the overall operation of the transceiver 416. In some embodiments, the processing circuitry 432 can facilitate a method to implement optical demultiplexing, as described herein.

The transceiver 416 or selected elements of the transceiver 416 may take the form of a pluggable card or controller for the device 410. For example, the transceiver 416 or selected elements of the transceiver 416 may be implemented on a network interface card (NIC).

The device 412 may include a transceiver 436 for sending and receiving signals, for example, data signals over a channel 409 of the communication network 408. The same or similar structure of the transceiver 416 may be applied to transceiver 436, and thus, the structure of transceiver 436 is not described separately.

Although not explicitly shown, it should be appreciated that devices 410 and 412 and the transceivers 416 and 420 may include other processing devices, storage devices, and/or communication interfaces generally associated with computing tasks, such as sending and receiving data.

### Example System for Demultiplexing an Optical Signal Using an Optical Device

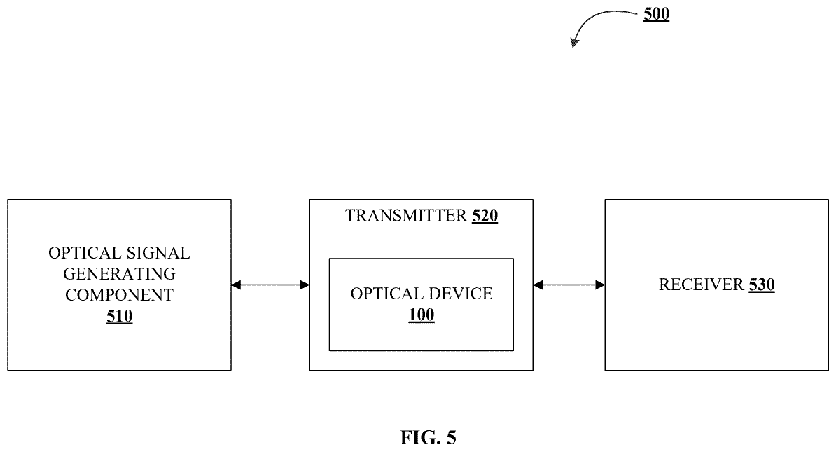

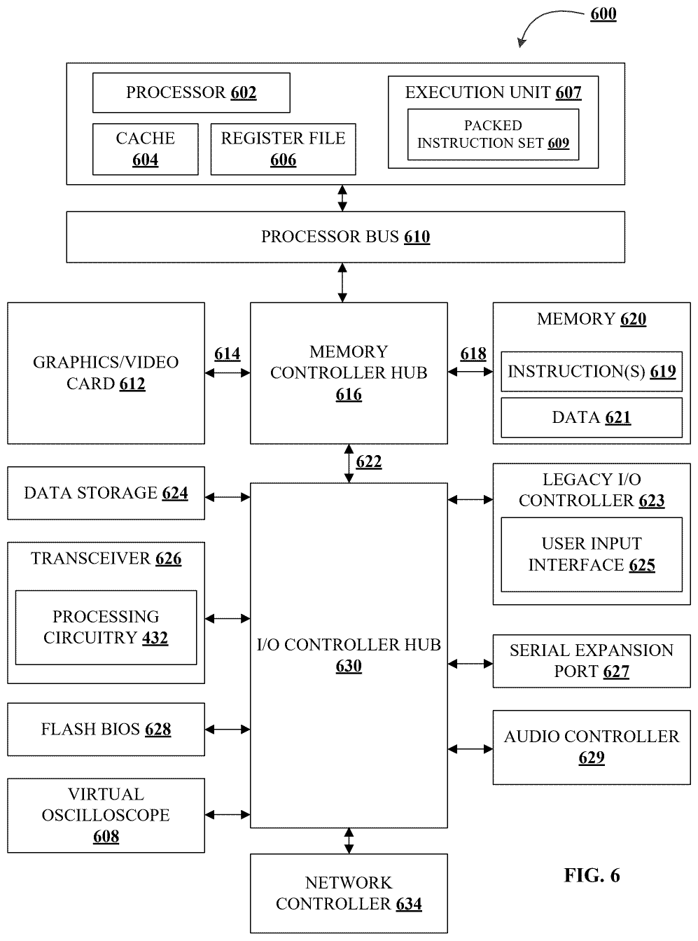

FIG. 5 illustrates an example system 500 for multiplexing or demultiplexing an optical signal using an optical device, in accordance with an embodiment of the disclosure. As shown, system 400 can include an optical signal generating component 510 including at least one optical signal generator. In some embodiments, optical signal generating component 510 includes a multi-wavelength signal generator configured to generate an optical signal having multiple wavelengths. In some embodiments, an optical signal generator is a laser. For example, the laser can be a multi-wavelength laser.

System 400 can further include transmitter 520. Transmitter 520 can be similar to transmitter 402 of FIG. 1. In some embodiments, and as shown in FIG. 4, transmitter 520 can include the optical device 100 as described above with reference to FIGS. 1-3. In some embodiments, optical device 100 can be separate from transmitter 520 (e.g., a standalone component).

System 400 can further include receiver 530 to receive optical signals from transmitter receiver 520 (e.g., modulated optical signal). Receiver 530 can be similar to receiver 104 of FIG. 4. In some embodiments, receiver 530 includes an optical device 100 for demultiplexing the optical signal.

### Example Computer System for Demultiplexing an Optical Signal Using an Optical Device

FIG. 6 illustrates an example computer system 600 including a transceiver including a chip-to-chip interconnect, in accordance with an embodiment of the disclosure. In at least one embodiment, computer system 600 may be a system with interconnected devices and components, an SOC, or some combination. In at least one embodiment, computer system 600 is formed with a processor 602 that may include execution units to execute an instruction. In at least one embodiment, computer system 600 may include, without limitation, a component, such as processor 602 to employ execution units including logic to perform algorithms for processing data. In at least one embodiment, computer system 600 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS' operating system available from Microsoft Corporation of Redmond, Wash., although other operating systems (UNIX and Linux for example), embedded software, and/or graphical user interfaces, may also be used.

In at least one embodiment, computer system 600 may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (DSP), an SoC, network computers (“NetPCs”), set-top boxes, network hubs, wide area network (“WAN”) switches, or any other system that may perform one or more instructions. In an embodiment, computer system 600 may be used in devices such as graphics processing units (GPUs), network adapters, central processing units and network devices such as switch (e.g., a high-speed direct GPU-to-GPU interconnect such as the NVIDIA GH100 NVLINK or the NVIDIA Quantum 2 64 Ports InfiniBand NDR Switch).

In at least one embodiment, computer system 600 may include, without limitation, processor 602 that may include, without limitation, one or more execution units 607 that may be configured to execute a Compute Unified Device Architecture (“CUDA”) (CUDA® is developed by NVIDIA Corporation of Santa Clara, CA) program. In at least one embodiment, a CUDA program is at least a portion of a software application written in a CUDA programming language. In at least one embodiment, computer system 600 is a single processor desktop or server system. In at least one embodiment, computer system 600 may be a multiprocessor system. In at least one embodiment, processor 602 may include, without limitation, a CISC microprocessor, a RISC microprocessor, a VLIW microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“Ll”) internal cache memory (“cache”) 604. In at least one embodiment, processor 602 may have a single internal cache or multiple levels of internal cache. In at least one embodiment, cache memory may reside external to processor 602. In at least one embodiment, processor 602 may also include a combination of both internal and external caches. In at least one embodiment, register file 606 may store different types of data in various registers including, without limitation, integer registers, floating point registers, status registers, and instruction pointer register.

In at least one embodiment, execution unit 607, including, without limitation, logic to perform integer and floating-point operations, also resides in processor 602. Processor 602 may also include a microcode (“ucode”) read only memory (“ROM”) that stores microcode for certain macro instructions. In at least one embodiment, execution unit 602 may include logic to handle packed instruction set 609. In at least one embodiment, by including packed instruction set 609 in an instruction set of general-purpose processor 602, along with associated circuitry to execute instructions, operations used by many multimedia applications may be performed using packed data in general-purpose processor 602. In at least one embodiment, many multimedia applications may be accelerated and executed more efficiently by using full width of a processor's data bus for performing operations on packed data, which may eliminate a need to transfer smaller units of data across a processor's data bus to perform one or more operations one data element at a time.

In at least one embodiment, an execution unit may also be used in microcontrollers, embedded processors, graphics devices, DSPs, and other types of logic circuits. In at least one embodiment, computer system 600 may include, without limitation, memory 620. In at least one embodiment, memory 620 may be implemented as a DRAM device, an SRAM device, flash memory device, or other memory device. Memory 620 may store instruction(s) 619 and/or data 621 represented by data signals that may be executed by processor 602.

In at least one embodiment, a system logic chip may be coupled to processor bus 610 and memory 620. In at least one embodiment, the system logic chip may include, without limitation, memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data and textures. In at least one embodiment, MCH 616 may direct data signals between processor 602, memory 620, and other components in computer system 600 and to bridge data signals between processor bus 610, memory 620, and system I/O 622. In at least one embodiment, system logic chip may provide a graphics port for coupling to a graphics controller. In at least one embodiment, MCH 616 may be coupled to memory 620 through high bandwidth memory path 618 and graphics/video card 612 may be coupled to MCH 616 through Accelerated Graphics Port (“AGP”) interconnect 614.

In at least one embodiment, computer system 600 may use system I/O 622 that is a proprietary hub interface bus to couple MCH 616 to I/O controller hub (“ICH”) 630. In at least one embodiment, ICH 630 may provide direct connections to some I/O devices via a local I/O bus. In at least one embodiment, local I/O bus may include, without limitation, a high-speed I/O bus for connecting peripherals to memory 620, a chipset, and processor 602. Examples may include, without limitation, audio controller 629, firmware hub (“flash BIOS”) 628, transceiver 626, a data storage 624, legacy I/O controller 623 containing user input interface 625 and a keyboard interface, serial expansion port 627, such as a USB, and network controller 634. Data storage 624 may comprise a hard disk drive, a floppy disk drive, a CD-ROM device, a flash memory device, or other mass storage device. In an embodiment, transceiver 626 includes a constrained FFE 608.

In at least one embodiment, FIG. 6 illustrates a system, which includes interconnected hardware devices or “chips” in transceiver 626—e.g., transceiver 626 includes a chip-to-chip interconnect including first device 410 and second device 412 as described with reference to FIG. 4). In at least one embodiment, FIG. 6 may illustrate an exemplary SoC. In at least one embodiment, devices illustrated in FIG. 6 may be interconnected with proprietary interconnects, standardized interconnects (e.g., PCIe), or some combination thereof. In at least one embodiment, one or more components of system 600 are interconnected using compute express link (“CXL”) interconnects. In an embodiment, transceiver 626 can include processing circuitry 132 as described with reference to FIG. 5. In such embodiments, processing circuitry 432 can facilitate a method to implement demultiplexing of an optical signal using the optical device 100. For example, processing circuitry 432 can implement techniques for demultiplexing an optical signal, as described with reference to FIGS. 1-4.

Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases the method may include additional steps. The steps and modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An optical device, comprising:
a first optical waveguide comprising a first grating structure; and
a second optical waveguide comprising a second grating structure, wherein the second optical waveguide is disposed proximate the first optical waveguide to enable optical coupling between the first optical waveguide and the second optical waveguide along an interaction length,
wherein a distance between the first optical waveguide and the second optical waveguide varies along the interaction length.

2. The optical device of claim 1, wherein the first grating structure and the second grating structure are configured to couple, from the first optical waveguide to the second optical waveguide, a subset of a plurality of wavelengths of an optical signal propagating through the first optical waveguide.

3. The optical device of claim 2, wherein the optical signal propagates via the first optical waveguide in a first direction, and
wherein coupling further comprises coupling the subset of the plurality of wavelengths of the optical signal from the first optical waveguide to the second optical waveguide in a direction opposite to the first direction.

4. The optical device of claim 1, wherein the optical device is a contra-directional grating-assisted coupler (CDGC).

5. The optical device of claim 1, wherein the distance between the first optical waveguide and the second optical waveguide varies along the interaction length according to a mathematical function.

6. The optical device of claim 5, wherein the mathematical function comprises at least one of a sine function, a cosine function, or a Gaussian function.

7. The optical device of claim 1, wherein a coupling strength between the first optical waveguide and the second optical waveguide along the interaction length changes based on the distance between the first optical waveguide and the second optical waveguide.

8. The optical device of claim 7, wherein the coupling strength between the first optical waveguide and the second optical waveguide is at a maximum where the distance between the first optical waveguide and the second optical waveguide is at a minimum, and wherein the coupling strength between the first optical waveguide and the second optical waveguide is at a minimum where the distance between the first optical waveguide and the second optical waveguide is at a maximum.

9. The optical device of claim 1, wherein the distance between the first optical waveguide and the second optical waveguide is at a minimum at a midpoint of the interaction length.

10. The optical device of claim 1, wherein the first grating structure and the second grating structure are corrugations.

11. A method for demultiplexing an optical signal using an optical device, the method comprising:
receiving an optical signal for propagation via a first optical waveguide, wherein the optical signal comprises a plurality of wavelengths;
coupling a subset of the plurality of wavelengths of the optical signal from the first optical waveguide to a second optical waveguide for propagation; and
transmitting, via the second optical waveguide, the subset of the plurality of wavelengths of the optical signal to an external device,
wherein a distance between the first optical waveguide and the second optical waveguide varies along an interaction length associated with the first optical waveguide and the second optical waveguide.

12. The method of claim 11, wherein the first optical waveguide comprises a first grating structure and the second optical waveguide comprises a second grating structure, and wherein the first grating structure and the second grating structure are configured to couple, from the first optical waveguide to the second optical waveguide, a subset of a plurality of wavelengths of an optical signal propagating through the first optical waveguide.

13. The method of claim 12, wherein the optical signal propagates via the first optical waveguide in a first direction, and
wherein coupling further comprises coupling the subset of the plurality of wavelengths of the optical signal from the first optical waveguide to the second optical waveguide in a direction opposite to the first direction.

14. The method of claim 12, wherein the second optical waveguide is disposed proximate to the first optical waveguide to enable coupling therebetween.

15. The method of claim 12, wherein the optical device is a contra-directional grating-assisted coupler (CDGC).

16. The method of claim 12, wherein the distance between the first optical waveguide and the second optical waveguide varies along the interaction length according to a mathematical function.

17. The method of claim 16, wherein the mathematical function comprises at least one of a sine function, a cosine function, or a Gaussian function.

18. A system comprising:
an optical signal generator configured to generate an optical signal, wherein the optical signal comprises a plurality of wavelengths; and
an optical device operatively coupled to the optical signal generator and configured to:
receive the optical signal via a first optical waveguide;
couple a subset of the plurality of wavelengths of the optical signal from the first optical waveguide to a second optical waveguide for propagation; and
transmit, via the second optical waveguide, the subset of the plurality of wavelengths of the optical signal to an external device,
wherein a distance between the first optical waveguide and the second optical waveguide varies along an interaction length associated with the first optical waveguide and the second optical waveguide.

19. The system of claim 18, wherein the first optical waveguide comprises a first grating structure and the second optical waveguide comprises a second grating structure, and wherein the first grating structure and the second grating structure are configured to couple, from the first optical waveguide to the second optical waveguide, a subset of a plurality of wavelengths of an optical signal propagating through the first optical waveguide.

20. The system of claim 19, wherein the optical signal propagates via the first optical waveguide in a first direction, and
wherein coupling further comprises coupling the subset of the plurality of wavelengths of the optical signal from the first optical waveguide to the second optical waveguide in a direction opposite to the first direction.
